(19) United States
(12) Patent Application Publication
(10) Pub. No.: US 2025/0274955 A1
(43) Pub. Date: Aug. 28, 2025

(54) Communication for Sidelink Relay

(71) Applicant: Apple Inc., CUPERTINO, CA (US)

(72) Inventors: Peng CHENG, Beijing (CN); Haijing HU, Los Gatos, CA (US); Zhibin WU, Los Altos, CA (US)

(21) Appl. No.: 18/857,973

(22) PCT Filed: Apr. 25, 2022
(86) PCT No.: PCT/CN2022/088962

§ 371 Date: Oct. 18, 2024

(51) Int. Cl. H04W 72/25; H04W 72/1268

(52) U.S. Cl. CPC H04W 72/25; H04W 72/1268

(57) ABSTRACT

Embodiments of the present disclosure relate to communication for sidelink relay. According to embodiments of the present disclosure, a first UE receives, from a network, a first message indicating that the first UE is switched to communicate with the network via a second UE in an idle or inactive state, and obtains, from the second UE or the network, a local ID of the first UE. Then the first UE performs, based on the local ID of the first UE, a data transmission with the network via the second UE. In this way, allocation of a local ID of a remote UE is clarified.

### TECHNICAL FIELD

Embodiments of the present disclosure generally relate to the field of telecommunications, and in particular, to communication for sidelink relay.

### BACKGROUND

Sidelink relay in the third generation partnership project (3GPP) release 17 supports a direct-to-indirect path switch when target relay user equipment (UE) is in an idle or inactive state. It has been agreed that a target relay UE may transmit a sidelink UE information (SUI) message to a target base station (BS) and get a local ID of a remote UE from the target BS, which is the same as a radio resource control (RRC) establishment procedure. However, it is still unclear how a remote UE can get its local ID. Thus, a solution of communication for sidelink relay needs to be further developed.

### SUMMARY

In general, example embodiments of the present disclosure provide a solution of communication for sidelink relay.

In a first aspect, there is provided a first UE. The first UE comprises: a transceiver and a processor. The transceiver is configured to communicate with a network directly or via another UE. The processor is communicatively coupled to the transceiver and configured to perform operations comprising: receiving, from the network, a first message indicating that the first UE is switched to communicate with the network via a second UE in an idle or inactive state; obtaining, from the second UE or the network, a local ID of the first UE; and performing, based on the local ID of the first UE, a data transmission with the base station via the second UE.

In a second aspect, there is provided a second UE. The second UE comprises a transceiver and a processor. The transceiver is configured to communicate with a network. The processor is communicatively coupled to the transceiver and configured to perform operations comprising: receiving, from a first UE, a response to a first message, the first message indicating that the first UE is switched to communicate with the network via the second UE in an idle or inactive state, the response indicating that the switching is completed; obtaining, from the first UE or the network, a local ID of the first UE; and transmitting the response to the network based on the local ID of the first UE.

In a third aspect, there is provided a BS. The BS comprises a transceiver and a processor. The transceiver is configured to communicate with a first UE directly or via another UE. The processor is communicatively coupled to the transceiver and configured to perform operations comprising: transmitting, to the first UE, a first message indicating that the first UE is switched to communicate with the base station via a second UE in an idle or inactive state; transmitting, to the first UE, a local ID of the first UE; and performing, based on the local ID of the first UE, a data transmission with the first UE via the second UE.

In a fourth aspect, there is provided a method of communication. The method comprises: receiving, at a first UE and from a network, a first message indicating that the first UE is switched to communicate with the network via a second UE in an idle or inactive state; obtaining, from the second UE or the network, a local identity (ID) of the first UE; and performing, based on the local ID of the first UE, a data transmission with the network via the second UE.

In a fifth aspect, there is provided a method of communication. The method comprises: receiving, at a second UE and from a first UE, a response to a first message, the first message indicating that the first UE is switched to communicate with a network via the second UE in an idle or inactive state, the response indicating that the switching is completed; obtaining, from the first UE or the network, a ID of the first UE; and transmitting the response to the network based on the local ID of the first UE.

In a sixth aspect, there is provided a method of communication. The method comprises: transmitting, at a base station and to a first UE, a first message indicating that the first UE is switched to communicate with the base station via a second UE in an idle or inactive state; transmitting, to the first UE, a ID of the first UE; and performing, based on the local ID of the first UE, a data transmission with the first UE via the second UE.

In a seventh aspect, there is provided a computer readable medium comprising program instructions for causing an apparatus to perform the method according to the fourth or fifth or sixth aspects of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A shows an example communication environment in which example embodiments of the present disclosure can be implemented;

FIG. 1B illustrates a schematic diagram of a protocol stack in which some embodiments of the present disclosure can be implemented;

FIG. 2 illustrates a schematic diagram illustrating a process of communication for sidelink relay according to some embodiments of the present disclosure;

FIG. 3 illustrates a schematic diagram illustrating a process of communication in which a remote UE obtains a local ID of the remote UE from a target BS after a path switch and a target relay UE obtains the local ID of the remote UE from the target BS in the path switch according to some embodiments of the present disclosure;

FIG. 4 illustrates a schematic diagram illustrating a process of communication in which a remote UE obtains a local ID of the remote UE from a target relay UE after a path switch and the target relay UE obtains the local ID of the remote UE from the target BS in the path switch according to some embodiments of the present disclosure;

FIG. 5 illustrates a schematic diagram illustrating a process of communication in which a remote UE and a target relay UE obtain a local ID of the remote UE from a target BS in a path switch according to some embodiments of the present disclosure;

FIG. 6 illustrates a schematic diagram illustrating a process of communication in which a remote UE obtains a local ID of the remote UE from a target BS in a path switch and a target relay UE obtains the local ID of the remote UE from the remote UE in the path switch according to some embodiments of the present disclosure;

FIG. 7 illustrates a flowchart of an example method of communication implemented at a first UE as a remote UE according to some embodiments of the present disclosure;

FIG. 8 illustrates a flowchart of an example method of communication implemented at a second UE as a target relay UE according to some embodiments of the present disclosure;

FIG. 9 illustrates a flowchart of an example method of communication implemented at a BS as a target BS according to some embodiments of the present disclosure; and

FIG. 10 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

In the context of the present disclosure, the term “local ID” may be interchangeably used with the term “temporary ID”, and the term “SRAP layer” may be interchangeably used with the term “adaptation layer”.

As mentioned above, although it is agreed that a target relay UE may transmit a SUI message to get a local ID of a remote UE, it is still unclear how a remote UE can get its local ID.

In view of this, embodiments of the present disclosure propose a solution for allocation of a local ID of remote UE, especially in a path switch to a target relay UE in an idle or inactive state. In this solution, a remote UE obtains a local ID of the remote UE from the target relay UE or a base station. The target relay UE obtains the local ID of the remote UE from the remote UE or the base station. Then the remote UE performs a data transmission with the base station via the target relay UE.

According to embodiments of the present disclosure, allocation of a local ID of remote UE is clarified.

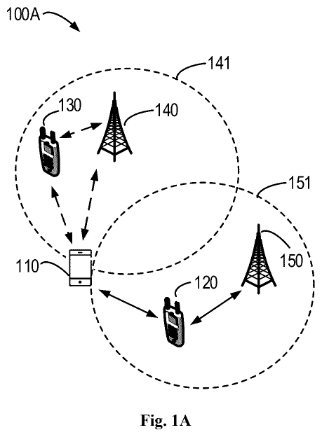

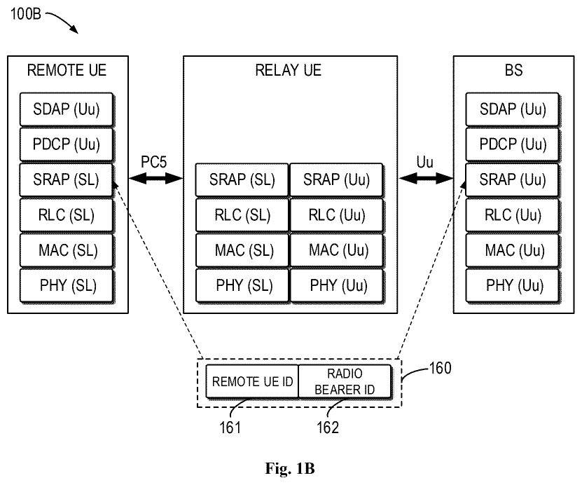

Principle and implementations of the present disclosure will be described in detail below with reference to FIGS. 1A to 10.

FIG. 1A shows an example communication environment 100A in which embodiments of the present disclosure can be implemented. As shown in FIG. 1A, the communication environment 100A may include a UE 110, a UE 120, a UE 130, a BS 140 and a BS 150. The BS 140 may provide a cell 141 serving one or more UEs, and the BS 150 may provide a cell 151 serving one or more UEs. In the example of FIG. 1A, the UE 110 and the UE 130 are located within the cell 141, and the UE 120 is located within the cell 151. The BS 140 and the BS 150 may form a network, for example, an access network to a core network (not shown).

In some embodiments, the UE 110 may directly communicate with the BS 140 when the UE 110 is located within the cell 141. In some embodiments, the UE 110 may communicate with the BS 140 via another UE (for example, the UE 130) when the UE 110 is located outside or within the cell 141. In this case, the UE 110 may be called as a remote UE and the UE 130 may be called as a relay UE. Similarly, the UE 120 may directly communicate with the BS 150 when the second UE 120 is located within the cell 151.

In some embodiments, a UE (for example, the UE 110, 120 or 130) and a BS (for example, the BS 140 or 150) may communicate with each other via a channel such as a wireless communication channel. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

In some embodiments, any two of UEs (for example, the UEs 110, 120 and 130) may communicate with each other via a sidelink channel such as a physical sidelink shared channel (PSSCH), a physical sidelink control channel (PSCCH), a physical sidelink feedback channel (PSFCH), a physical sidelink broadcast channel (PSBCH) or the like.

The communications in the communication environment 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the number of devices or cells in FIG. 1A is given for the purpose of illustration without suggesting any limitations to the present disclosure. The communication environment 100A may include any suitable number of UEs or BSs or cells adapted for implementing implementations of the present disclosure.

The communications between a UE and a BS or between UEs in communication environment 100A may be performed in accordance with a protocol stack. Generally speaking, for a communication device (such as a UE or a BS), there are a plurality of entities for a plurality of network protocol layers in a protocol stack, which can be configured to implement corresponding processing on data or signaling transmitted from the communication device and received by the communication device. FIG. 1B illustrates a schematic diagram 100B of a protocol stack in which some embodiments of the present disclosure can be implemented.

As shown in FIG. 1B, a remote UE may comprise entities of a physical (PHY) layer, a medium access control (MAC) layer, a radio link control (RLC) layer and a sidelink relay adaptation protocol (SRAP) layer for a sidelink (SL) interface, and entities of a packet data convergence protocol (PDCP) layer and a service data adaptation protocol (SDAP) layer for a Uu interface. A relay UE may comprise entities of a PHY layer, a MAC layer, a RLC layer and a SRAP layer for a SL interface, and entities of a PHY layer, a MAC layer, a RLC layer and a SRAP layer for a Uu interface. A BS may comprise entities of a PHY layer, a MAC layer, a RLC layer, a SRAP layer, a PDCP layer and a SDAP layer for a Uu interface.

With reference to FIG. 1B, a single Uu SRAP entity (may be also referred to as a Uu adaptation layer herein) is configured in the relay UE, while one PC5 SRAP entity (may be also referred to as a PC5 adaptation layer herein) is used for handling the remote UE. The PC5 adaptation layer may support the adaptation layer on PC5 for bearer mapping only, with exceptions: adaptation layer is not present over PC5 hop for signaling radio bearer 0 (SRB0); adaptation layer is not present over PC5 hop for broadcast control channel (BCCH) and paging control channel (PCCH); and Uu radio link failure (RLF) is not indicated in an adaptation layer header (for convenience, also referred to as a SRAP header herein). For the Uu adaptation layer, a serving BS of relay UE assigns a local ID of remote UE. Even for the first UL RRC message (SRB0), the relay UE is configured in advance with some default local IDs to be used. As shown in FIG. 1B, a SRAP header 160 may comprise a remote UE ID 161 and a radio bearer ID 162. The remote UE ID 161 may comprise a local ID of the remote UE. The radio bearer ID 162 may comprise a Uu radio bearer ID of the remote UE.

Return to FIG. 1A, in some scenarios, the UE 110 may direct communicate with the BS 140 in earlier stage. As the UE 110 moves, the UE 110 may need to perform a path switch so as to communicate with the BS 150 via the UE 120. This scenario is called as a direct-to-indirect path switch. In some scenarios, the UE 110 may communicate with the BS 140 via the UE 130 in earlier stage. As the UE 110 moves, the UE 110 may need to perform a path switch so as to communicate with the BS 150 via the UE 120. This scenario is called as an indirect-to-indirect path switch. In these scenarios, the UE 110 is called as a remote UE, the UE 120 is called as a target relay UE, the BS 140 serving the remote UE is called as a source BS, and the BS 150 serving the target relay UE is called as a target BS.

It is to be understood that although the BS 140 and the BS 150 are shown as different BSs in FIG. 1A, the BS 140 and the BS 150 may also be the same BS. In this case, the source BS and the target BS may be the same BS.

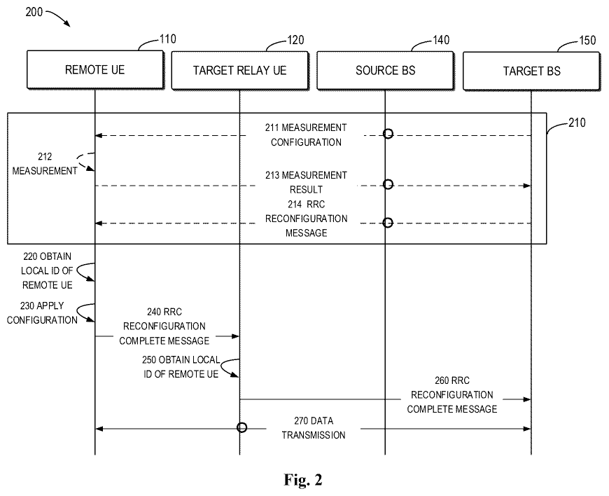

For the direct-to-indirect path switch and the indirect-to-indirect path switch, embodiments of the present disclosure provide a solution for allocation of a local ID of a remote UE when a target relay UE is in an idle or inactive state. For illustration, the solution will be described in connection with FIG. 2 below.

FIG. 2 illustrates a schematic diagram illustrating a process 200 of communication in sidelink relay according to some embodiments of the present disclosure. For the purpose of discussion, the process 200 will be described with reference to FIG. 1A. The process 200 may involve the UE 110, the UE 120, the BS 140 and the BS 150 as illustrated in FIG. 1A. The steps and the order of the steps in FIG. 2 are merely for illustration, and not for limitation. It is assumed that the UE 110 serves as a remote UE, and the UE 120 serves as a target relay UE in an idle or inactive state. Accordingly, the BS 140 serves as a source BS and the BS 150 serves as a target BS. For convenience, the UE 110 is also called as remote UE 110, the UE 120 is also called as target relay UE 120, the BS 140 is also called as source BS 140, and the BS 150 is also called as target BS 150 hereinafter.

As shown in FIG. 2, the target BS 150 transmits 210, to the remote UE 110, a message (for convenience, also referred to as a first message herein) indicating that the remote UE 110 is switched to communicate with the target BS 150 via the target relay UE 120. The first message may comprise a configuration for the path switch. In some embodiments, the first message may be a RRC reconfiguration message. Of course, any other suitable messages are also feasible.

In some embodiments, the target BS 150 may transmit 211 a measurement configuration to the remote UE 110 via the source BS 140. The remote UE 110 may perform 212 a measurement based on the measurement configuration, and report 213 the measurement to the target BS 150 via the source BS 140. Based on the reporting, the target BS 150 may decide to switch to the target relay UE 120, and then transmit 214 a path switch command (i.e., the first message) to the UE 110 via the source BS 140. In some embodiments where the source BS 140 and the target BS 150 are the same BS, the target BS 150 may directly transmit the path switch command to the remote UE 110.

Upon reception of the first message, the remote UE 110 obtains 220 a local ID of the remote UE 110. The local ID of the remote UE 110 is assigned by the target BS 150. In some embodiments, the remote UE 110 may obtain the local ID of the remote UE 110 from the target BS 150. In some embodiments, the remote UE 110 may obtain the local ID of the remote UE 110 from the target relay UE 120.

Upon reception of the first message, the remote UE 110 may apply 230 the configuration for the path switch, and transmit 240, to the target relay UE 120, a response to the first message. The response indicates that the path switch is completed. For example, the remote UE 110 may transmit a RRC reconfiguration complete message to the target relay UE 120 as the response to the first message.

Upon reception of the response to the first message, the target relay UE 120 obtains 250 the local ID of the remote UE 110. In some embodiments, the target relay UE 120 may obtain the local ID of the remote UE 110 from the target BS 150. In some embodiments, the target relay UE 120 may obtain the local ID of the remote UE 110 from the remote UE 110. Upon establishment of a connection with the target BS 150, the target relay UE 120 may transmit 260, to the target BS 150, a message indicating that the path switch is completed.

Upon reception of the message indicating that the path switch is completed, the target BS 150 may perform 270 a data transmission with the remote UE 110 via the target relay UE 120.

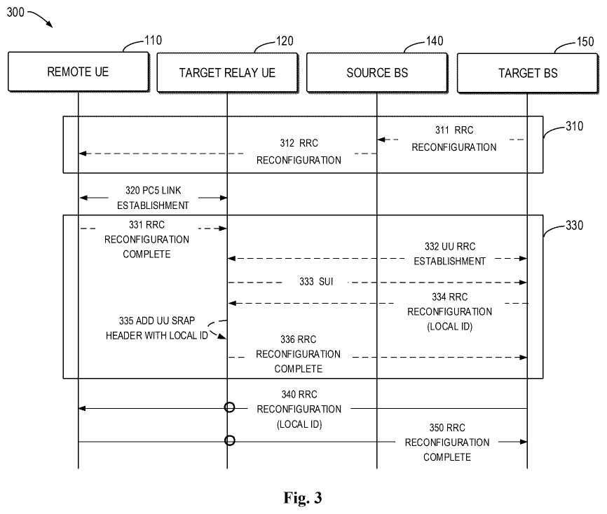

In this way, a remote UE and a target relay UE may obtain a local ID of the remote UE and a sidelink relay communication may be facilitated. For illustration, some example embodiments for the solution will be described below in connection with FIGS. 3 to 6.

FIG. 3 illustrates a schematic diagram illustrating a process 300 of communication in which a remote UE obtains a local ID of the remote UE from a target BS after a path switch and a target relay UE obtains the local ID of the remote UE from the target BS in the path switch according to some embodiments of the present disclosure. For the purpose of discussion, the process 300 will be described with reference to FIG. 1A. The steps and the order of the steps in FIG. 3 are merely for illustration, and not for limitation.

With reference to FIG. 3, the target BS 150 may transmit 310, to the remote UE 110, the first message indicating that the remote UE 110 is switched to communicate with the target BS 150 via the target relay UE 120. The target relay UE 120 is in an idle or inactive state. In this embodiment, the first message does not indicate the local ID of the remote UE 110. In other words, the target BS 150 does not provide the local ID to the remote UE 110 in a path switch command. For example, the target BS 150 may transmit a RRC reconfiguration message that does not comprise the local ID of the remote UE 110. Of course, any other suitable messages are also feasible.

In some embodiments, the target BS 150 may transmit 311 the first message to the source BS 140 and the source BS 140 may forward 312 the first message to the remote UE 110. In some embodiments where the target BS 150 and the source BS 140 are the same BS, the target BS 150 may directly transmit the first message to the remote UE 110.

Upon reception of the first message, the remote UE 110 may establish 320 a sidelink connection (for example, a PC5 link) with the target relay UE 120. Then the remote UE 110 may transmit 330, to the target BS 150 and via the target relay UE 120, a response to the first message indicating that the switching is completed. In this case, the response does not comprise the local ID in a SRAP header or does not comprise the SRAP header. For example, the remote UE 110 may transmit a RRC reconfiguration complete message in which a local ID field in a PC5 SRAP header is absent or the PC5 SRAP header is absent. Of course, any other suitable messages are also feasible.

In some embodiments, the remote UE 110 may transmit 331, to the target relay UE 120, the response to the first message. Upon reception of the response to the first message, the target relay UE 120 may establish 332 a connection (for example, Uu RRC connection) with the target BS 150. The target relay UE 120 may transmit 333, to the target BS 150, a request for obtaining the local ID of the remote UE 110. For example, the target relay UE 120 may transmit a SUI message or any other suitable messages. In response to the request, the target BS 150 may transmit 334, to the target relay UE 120, a message (for convenience, also referred to as a fourth message herein) indicating the local ID of the remote UE 110. For example, the target BS 150 may transmit a RRC reconfiguration message comprising the local ID of the remote UE 110 to the target relay UE 120. Of course, any other suitable messages are also feasible.

The target relay UE 120 may add 335 the local ID of the remote UE 110 in a Uu SRAP header of a response to the fourth message. The response to the fourth message indicates that the switching is completed. Then the target relay UE 120 may transmit 336, to the target BS 150, the response to the fourth message. For example, the target relay UE 120 may transmit, as the response to the fourth message, a RRC reconfiguration complete message to indicate that the switching is completed. Of course, any other suitable messages are also feasible.

Upon reception of the response (for example, RRC reconfiguration complete message) to the fourth message, the target BS 150 may transmit 340, to the remote UE 110 and via the target relay UE 120, a message (for convenience, also referred to as a second message herein) indicating the local ID of the remote UE 110. In some embodiments, the second message may be a RRC reconfiguration message comprising the local ID of the remote UE 110. It is to be understood that any other suitable messages are also feasible.

Upon reception of the second message, the remote UE 110 may transmit 350, to the target BS 150 and via the target relay UE 120, a response to the second message. In this case, a PC5 SRAP header is present in the response to the second message. For example, the remote UE 110 may transmit, as the response to the second message, a RRC reconfiguration complete message to the target BS 150 via the target relay UE 120. It is to be understood that any other suitable messages are also feasible. In some embodiments where there is uplink data to be transmitted at the remote UE 110, the remote UE 110 may multiplex the uplink data with the response to the second message. In this case, the remote UE may have to delay its uplink data transmission by at least two RRC messages.

In other words, in the process 300, if sl-PathSwitchConfig is included in a RRC reconfiguration message, a remote UE may get a local ID of the remote UE from a followed RRC reconfiguration message.

With the process 300, after transmitting a local ID to a target relay UE, a target BS may transmit the same local ID to a remote UE (for example, via a Uu RRC message). Thus, a local ID collision issue may be avoided. A target BS may not want to allocate a local ID to a remote UE until it is certain that the remote UE will be able to connect to the target BS via a target relay UE under coverage of the target BS. Given the uncertainty of a direct-to-indirect path switch or an indirect-to-indirect path switch, it is better for a target BS to wait to a target relay UE to get connected first. Otherwise, the target BS needs additional implementation to allocate or recycle local IDs which are not to be used.

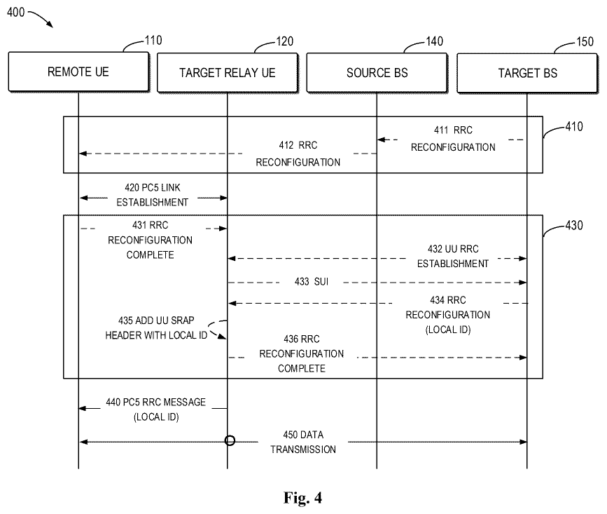

FIG. 4 illustrates a schematic diagram illustrating a process 400 of communication in which a remote UE obtains a local ID of the remote UE from a target relay UE after a path switch and the target relay UE obtains the local ID of the remote UE from the target BS in the path switch according to some embodiments of the present disclosure. For the purpose of discussion, the process 400 will be described with reference to FIG. 1A. The steps and the order of the steps in FIG. 4 are merely for illustration, and not for limitation.

With reference to FIG. 4, the target BS 150 may transmit 410, to the remote UE 110, the first message indicating that the remote UE 110 is switched to communicate with the target BS 150 via the target relay UE 120. The target relay UE 120 is in an idle or inactive state. In this embodiment, the first message does not indicate the local ID of the remote UE 110. In other words, the target BS 150 does not provide the local ID to the remote UE 110 in a path switch command. For example, the target BS 150 may transmit a RRC reconfiguration message that does not comprise the local ID of the remote UE 110. Of course, any other suitable messages are also feasible.

In some embodiments, the target BS 150 may transmit 411 the first message to the source BS 140 and the source BS 140 may forward 412 the first message to the remote UE 110. In some embodiments where the target BS 150 and the source BS 140 are the same BS, the target BS 150 may directly transmit the first message to the remote UE 110.

Upon reception of the first message, the remote UE 110 may establish 420 a sidelink connection (for example, a PC5 link) with the target relay UE 120. Then the remote UE 110 may transmit 430, to the target BS 150 and via the target relay UE 120, a response to the first message indicating that the switching is completed. In this case, the response does not comprise the local ID in a SRAP header or does not comprise the SRAP header. For example, the remote UE 110 may transmit a RRC reconfiguration complete message in which a local ID field in a PC5 SRAP header is absent or the PC5 SRAP header is absent. Of course, any other suitable messages are also feasible.

In some embodiments, the remote UE 110 may transmit 431, to the target relay UE 120, the response to the first message. Upon reception of the response to the first message, the target relay UE 120 may establish 432 a connection (for example, Uu RRC connection) with the target BS 150. The target relay UE 120 may transmit 433, to the target BS 150, a request for obtaining the local ID of the remote UE 110. For example, the target relay UE 120 may transmit a SUI message or any other suitable messages. In response to the request, the target BS 150 may transmit 434, to the target relay UE 120, a message (for convenience, also referred to as a fourth message herein) indicating the local ID of the remote UE 110. For example, the target BS 150 may transmit a RRC reconfiguration message comprising the local ID of the remote UE 110 to the target relay UE 120. Of course, any other suitable messages are also feasible.

The target relay UE 120 may add 435 the local ID of the remote UE 110 in a Uu SRAP header of a response to the fourth message. The response to the fourth message indicates that the switching is completed. Then the target relay UE 120 may transmit 436, to the target BS 150, the response to the fourth message. For example, the target relay UE 120 may transmit, as the response to the fourth message, a RRC reconfiguration complete message to indicate that the switching is completed. Of course, any other suitable messages are also feasible.

Upon transmission of the response (for example, RRC reconfiguration complete message) to the fourth message, the target relay UE 120 may transmit 440, to the remote UE 110, a message (for convenience, also referred to as a third message herein) indicating the local ID of the remote UE 110. In some embodiments, the third message may be a PC5 RRC message. For example, the target relay UE 120 may reuse an existing PC5 RRC message such as a NotificationMessageSidelink message to transmit the local ID to the remote UE 110. It is to be understood that any other existing or newly defined PC5 RRC messages are also feasible.

Upon reception of the third message, the remote UE 110 may perform 450 a data transmission with the target BS 150 via the target relay UE 120. In some embodiments where there is uplink data to be transmitted at the remote UE 110, the remote UE 110 may transmit the uplink data to the target BS 150 via the target relay UE 120. A PC5 SRAP header is present in the uplink data. In this case, the remote UE may also have to delay its uplink data transmission by at least two RRC messages.

In other words, in the process 400, if sl-PathSwitchConfig is included in a RRC reconfiguration message, a remote UE may get a local ID of the remote UE from a followed PC5 RRC message.

With the process 400, upon reception of a local ID from a target BS, a target relay UE may transmit the same local ID to a remote UE (for example, via a PC5 RRC message). Thus, a local ID collision issue may also be avoided. A target BS may not want to allocate a local ID to a remote UE until it is certain that the remote UE will be able to connect to the target BS via a target relay UE under coverage of the target BS. Given the uncertainty of a direct-to-indirect path switch or an indirect-to-indirect path switch, it is better for a target BS to wait to a target relay UE to get connected first. Otherwise, the target BS needs additional implementation to allocate or recycle local IDs which are not to be used.

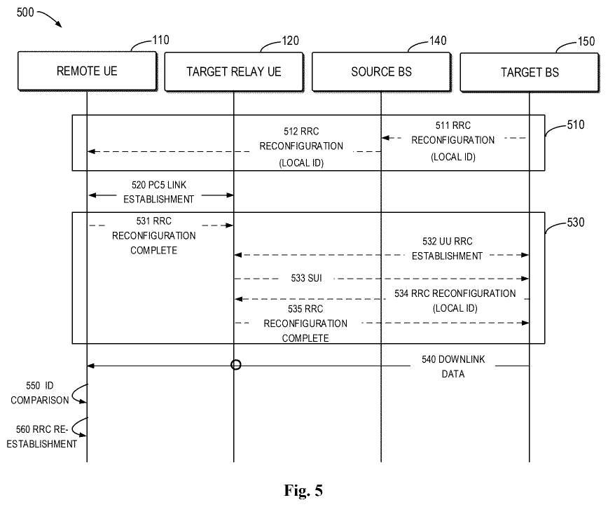

FIG. 5 illustrates a schematic diagram illustrating a process 500 of communication in which a remote UE and a target relay UE obtain a local ID of the remote UE from a target BS in a path switch according to some embodiments of the present disclosure. For the purpose of discussion, the process 500 will be described with reference to FIG. 1A. The steps and the order of the steps in FIG. 5 are merely for illustration, and not for limitation.

With reference to FIG. 5, the target BS 150 may transmit 510, to the remote UE 110, the first message indicating that the remote UE 110 is switched to communicate with the target BS 150 via the target relay UE 120. The target relay UE 120 is in an idle or inactive state. In this embodiment, the first message further indicates a local ID of the remote UE 110. In other words, the target BS 150 provides the local ID to the remote UE 110 in a path switch command. For example, the target BS 150 may transmit a RRC reconfiguration message that comprises the local ID of the remote UE 110. Of course, any other suitable messages are also feasible.

In some embodiments, the target BS 150 may transmit 511 the first message to the source BS 140 and the source BS 140 may forward 512 the first message to the remote UE 110. In some embodiments where the target BS 150 and the source BS 140 are the same BS, the target BS 150 may directly transmit the first message to the remote UE 110.

Upon reception of the first message, the remote UE 110 may establish 520 a sidelink connection (for example, a PC5 link) with the target relay UE 120. Then the remote UE 110 may transmit 530, to the target BS 150 and via the target relay UE 120, a response to the first message indicating that the switching is completed. In this case, the response comprises the local ID in a SRAP header. For example, the remote UE 110 may transmit a RRC reconfiguration complete message in which a PC5 SRAP header with a local ID field is present. Of course, any other suitable messages are also feasible.

In some embodiments where there is uplink data to be transmitted at the remote UE 110, the remote UE 110 may multiplex the uplink data with the response (for example, RRC reconfiguration complete message) to the first message. In this way, uplink data at a remote UE may be transmitted as early as the first RRC reconfiguration complete message. Thus, no latency for uplink data transmission is caused.

In some embodiments, the remote UE 110 may transmit 531, to the target relay UE 120, the response to the first message. Upon reception of the response to the first message, the target relay UE 120 may establish 532 a connection (for example, Uu RRC connection) with the target BS 150. The target relay UE 120 may transmit 533, to the target BS 150, a request for obtaining the local ID of the remote UE 110. For example, the target relay UE 120 may transmit a SUI message or any other suitable messages. In response to the request, the target BS 150 may transmit 534, to the target relay UE 120, a message (for convenience, also referred to as a fourth message herein) indicating the local ID of the remote UE 110. In this embodiment, the target BS 150 ensures that the local ID comprised in the fourth message is the same as the local ID comprised in the first message. For example, the target BS 150 may transmit a RRC reconfiguration message comprising the local ID of the remote UE 110 to the target relay UE 120. Of course, any other suitable messages are also feasible.

The target relay UE 120 may transmit 535, to the target BS 150, a response to the fourth message. For example, the target relay UE 120 may transmit, as the response to the fourth message, a RRC reconfiguration complete message to indicate that the switching is completed. Of course, any other suitable messages are also feasible.

Then the remote UE 110 may perform a data transmission with the target BS 150 via the target relay UE 120. In some embodiments where there is uplink data multiplexed with the response to the first message, the target relay UE 120 may multiplex the uplink data with the response (for example, RRC reconfiguration complete message) to the fourth message. In this way, uplink data from a remote UE is forwarded by a target relay UE to a target BS.

In some embodiments, the remote UE 110 may receive 540 downlink data from the target BS 150 via the target relay UE 120. The remote UE 110 may determine 550 whether an ID of the remote UE 110 in a SRAP header of the downlink data is different from the local ID obtained from the first message. If the ID of the remote UE 110 in the SRAP header of the downlink data is different from the local ID in the first message, the remote UE may trigger 560 a RRC re-establishment procedure.

In other words, in the process 500, if sl-PathSwitchConfig is included in a RRC reconfiguration message, a remote UE may get a local ID of the remote UE from sl-PathSwitchConfig. It is up to a target BS to ensure that a local ID provided in a path switch command is the same as a local ID acquired by a remote UE. If a remote UE identifies that a local ID in a PC5 SRAP header of the followed downlink transmission is different from a local ID received in a path switch command, the remote UE can declare error and trigger a RRC re-establishment procedure.

With the process 500, a target BS needs to ensure that a local ID provided in a path switch command is the same as a local ID acquired via a SUI message. Although a target BS may need additional implementation to allocate or recycle local IDs which are not to be used, no latency for uplink data transmission is caused.

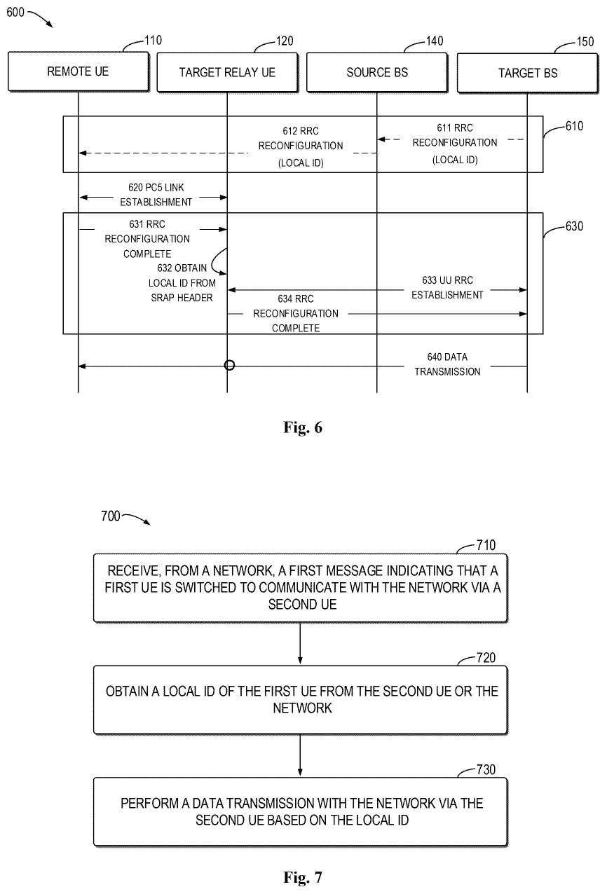

FIG. 6 illustrates a schematic diagram illustrating a process 600 of communication in which a remote UE obtains a local ID of the remote UE from a target BS in a path switch and a target relay UE obtains the local ID of the remote UE from the remote UE in the path switch according to some embodiments of the present disclosure. For the purpose of discussion, the process 600 will be described with reference to FIG. 1A. The steps and the order of the steps in FIG. 6 are merely for illustration, and not for limitation.

With reference to FIG. 6, the target BS 150 may transmit 610, to the remote UE 110, the first message indicating that the remote UE 110 is switched to communicate with the target BS 150 via the target relay UE 120. The target relay UE 120 is in an idle or inactive state. In this embodiment, the first message further indicates a local ID of the remote UE 110. In other words, the target BS 150 provides the local ID to the remote UE 110 in a path switch command. For example, the target BS 150 may transmit a RRC reconfiguration message that comprises the local ID of the remote UE 110. Of course, any other suitable messages are also feasible.

In some embodiments, the target BS 150 may transmit 611 the first message to the source BS 140 and the source BS 140 may forward 612 the first message to the remote UE 110. In some embodiments where the target BS 150 and the source BS 140 are the same BS, the target BS 150 may directly transmit the first message to the remote UE 110.

Upon reception of the first message, the remote UE 110 may establish 620 a sidelink connection (for example, a PC5 link) with the target relay UE 120. Then the remote UE 110 may transmit 630, to the target BS 150 and via the target relay UE 120, a response to the first message indicating that the switching is completed. In this case, the response comprises the local ID in a SRAP header. For example, the remote UE 110 may transmit a RRC reconfiguration complete message in which a PC5 SRAP header with a local ID field is present. Of course, any other suitable messages are also feasible.

In some embodiments where there is uplink data to be transmitted at the remote UE 110, the remote UE 110 may multiplex the uplink data with the response (for example, RRC reconfiguration complete message) to the first message. In this way, uplink data at a remote UE may be transmitted as early as the first RRC reconfiguration complete message. Thus, no latency for uplink data transmission is caused.

In some embodiments, the remote UE 110 may transmit 631, to the target relay UE 120, the response to the first message. Upon reception of the response to the first message, the target relay UE 120 may obtain 632 the local ID from the PC5 SRAP header of the response to the first message. The target relay UE 120 may establish 633 a connection with the target BS 150 and transmit 634 the response to the first message to the target BS 150. In some embodiments where there is uplink data multiplexed with the response to the first message, the target relay UE 120 may transmit the response multiplexed with the uplink data to the target BS 150.

Then the remote UE 110 may perform 640 a data transmission with the target BS 150 via the target relay UE 120.

In other words, in the process 600, if sl-PathSwitchConfig is included in a RRC reconfiguration message, a remote UE may get a local ID of the remote UE from sl-PathSwitchConfig.

With the process 600, a target relay UE does not require a local ID of a remote UE via SUI. The target relay UE just reads the local ID of the remote UE from a PC5 SRAP header of a response (for example, a RRC reconfiguration complete message) to the first message, and uses the local ID in all followed uplink and downlink messages. Thus, uplink data at a remote UE can be transmitted as early as the first RRC reconfiguration complete message and no latency for uplink data transmission is caused. Further, there is no new requirement on the network.

Corresponding to the above processes, embodiments of the present disclosure also provide methods implemented at a remote UE, a target relay UE and a target BS. These methods will be described below in connection with FIGS. 7 to 9.

FIG. 7 illustrates a flowchart of an example method 700 of communication implemented at a first UE as a remote UE according to some embodiments of the present disclosure. The method 700 can be implemented at a device, for example, the remote UE 110 shown in FIG. 1A. It is to be understood that the method 700 may include additional blocks not shown and/or may omit some shown blocks, and the scope of the present disclosure is not limited in this regard.

At block 710, a first UE (for example, the remote UE 110) receives, from the network (for example, the target BS 150), a first message (i.e., path switch command) indicating that the remote UE 110 is switched to communicate with the target BS 150 via a second UE (for example, the target relay UE 120). The target relay UE 120 is in an idle or inactive state. In some embodiments, the remote UE 110 may receive the first message from the target BS 150 via the source BS 140. In some embodiments where the target BS 150 and the source BS 140 are the same BS, the remote UE 110 may receive the first message from the target BS 150 directly.

At block 720, the remote UE 110 obtains a local ID of the remote UE 110 from the target relay UE 120 or the target BS 150.

At block 730, the remote UE 110 performs, based on the local ID of the remote UE 110, a data transmission with the target BS 150 via the target relay UE 120.

In some embodiments, the first message does not indicate the local ID of the remote UE 110. In these embodiments, the remote UE 110 may establish a sidelink connection with the target relay UE 120, and transmit, to the target BS 150 and via the target relay UE 120, a response to the first message indicating that the switching is completed. The response does not comprise the local ID in a SRAP header or does not comprise the SRAP header. In these embodiments, the remote UE 110 may receive, from the target BS 150 and via the target relay UE 120, a second message indicating the local ID of the remote UE 110. In some alternative or additional embodiments, the remote UE 110 may transmit, to the target BS 150 and via the target relay UE 120, uplink data multiplexed with a response to the second message. In this way, a remote UE may obtain its local ID from the network after a path switch and perform a data transmission with the network based on the local ID.

Alternatively, the remote UE 110 may receive, from the target relay UE 120 and via the sidelink connection, a third message indicating the local ID of the remote UE 110. In some embodiments, the remote UE 110 may transmit, to the target BS 150 and via the target relay UE 120, uplink data comprising the local ID in a SRAP header. In this way, a remote UE may obtain its local ID from a target relay UE after a path switch and perform a data transmission with the network based on the local ID.

Alternatively, the first message may further indicate the local ID of the remote UE 110. In these embodiments, the remote UE 110 may obtain the local ID of the remote UE 110 from the first message. In some embodiments, the remote UE 110 may establish a sidelink connection with the target relay UE 120, and transmit, to the target BS 150 and via the target relay UE 120, a response to the first message indicating that the switching is completed. The response comprises the local ID in a SRAP header. In some embodiments, the remote UE 110 may transmit, to the target BS 150 and via the target relay UE 120, uplink data multiplexed with the response to the first message.

In some embodiments, the remote UE 110 may further receive downlink data from the target BS 150 via the target relay UE 120. If an ID of the remote UE 110 in a SRAP header associated with the downlink data is different from the local ID obtained from the first message, the remote UE 110 may trigger a RRC re-establishment procedure.

With the method 700, a remote UE may obtain its local ID and perform a data transmission with the network based on the local ID.

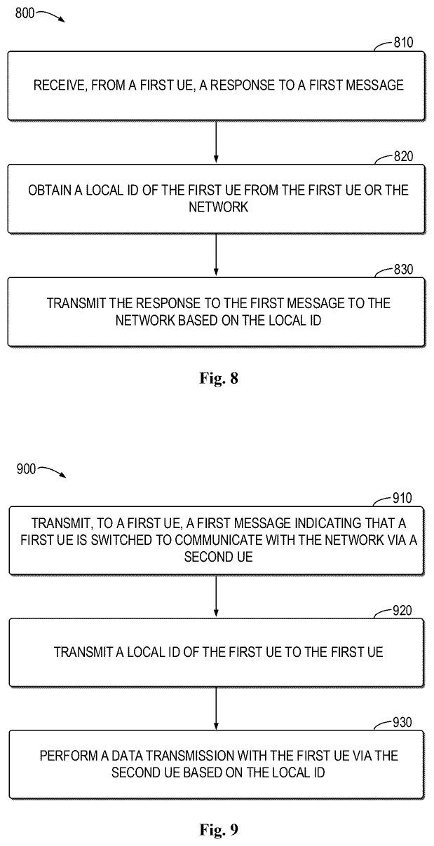

FIG. 8 shows a flowchart of an example method 800 of communication implemented at a second UE as a target relay UE according to some embodiments of the present disclosure. The method 800 can be implemented at a device, for example, the target relay UE 120 shown in FIG. 1. It is to be understood that the method 800 may include additional blocks not shown and/or may omit some shown blocks, and the scope of the present disclosure is not limited in this regard.

At block 810, a second UE (for example, the target relay UE 120) receives, from a first UE (for example, the remote UE 110), a response to a first message. The first message indicates that the remote UE 110 is switched to communicate with the network (for example, the target BS 150) via the target relay UE 120 in an idle or inactive state. The response indicates that the switching is completed.

At block 820, the target relay UE 120 obtains, from the remote UE 110 or the target BS 150, a local ID of the remote UE 110.

At block 830, the target relay UE 120 transmits, to the target BS 150, the response to the first message based on the local ID of the remote UE 110.

In some embodiments, the response does not comprise the local ID in a SRAP header or does not comprise the SRAP header. In these embodiments, the target relay UE 120 may establish a connection with the target BS 150, and transmit, to the target BS 150, a request for obtaining the local ID of the remote UE 110. Then, the target relay UE 120 may receive, from the target BS 150, a fourth message indicating the local ID of the remote UE 110. In this way, a target relay UE may obtain a local ID of a remote UE from a network.

In some embodiments, the target relay UE 120 may further transmit, to the remote UE, a third message indicating the local ID of the remote UE. In this way, a target relay UE may inform a remote UE of the same local ID. In some embodiments, the target relay UE 120 may further receive, from the remote UE 110, uplink data comprising the local ID in a SRAP header, and transmit the uplink data to the target BS 150. In this way, a sidelink relay communication may be performed based on a local ID of a remote UE.

Alternatively, the response may comprise the local ID in a SRAP header. In some embodiments, the target relay UE 120 may establish a connection with the target BS 150, and transmit, to the target BS 150, a request for obtaining the local ID of the remote UE 110. Then, the target relay UE 120 may receive, from the target BS 150, a fourth message indicating the local ID of the remote UE 110. In this way, a target relay UE may obtain the same local ID of a remote UE from a network.

In some embodiments, the target relay UE 120 may receive, from the remote UE 110, uplink data multiplexed with the response to the first message. In these embodiments, the target relay UE 120 may transmit, to the target BS 150, the uplink data multiplexed with a response to the fourth message.

In some alternative embodiments where the response may comprise the local ID in a SRAP header, the target relay UE 120 may obtain the local ID from the SRAP header. That is, a target relay UE may obtain the same local ID of a remote UE from the remote UE. In this case, the target relay UE 120 may establish a connection with the target BS 150, and transmit the response to the first message to the target BS 150.

In some embodiments, the target relay UE 120 may receive, from the remote UE 110, uplink data multiplexed with the response to the first message. In these embodiments, the target relay UE 120 may transmit, to the target BS 150, the uplink data multiplexed with a response to the first message.

With the method 800, a target relay UE may obtain a local ID of a remote UE and forward a data transmission between the remote UE and the network based on the local ID.

FIG. 9 illustrates a flowchart of an example method 900 of communication implemented at a BS as a target BS according to some embodiments of the present disclosure. The method 900 can be implemented at a device, for example, the target BS 150 shown in FIG. 1A. It is to be understood that the method 900 may include additional blocks not shown and/or may omit some shown blocks, and the scope of the present disclosure is not limited in this regard.

At block 910, a BS (for example, the target BS 150) transmits, to a first UE (for example, the remote UE 110), a first message indicating that the remote UE 110 is switched to communicate with the target BS 150 via a second UE (for example, the target relay UE 120) in an idle or inactive state. In some embodiments, the target BS 150 may transmit the first message to the remote UE 110 via the source BS 140. In some embodiments wherein the target BS 150 and the source BS 140 are the same BS, the target BS 150 may directly transmit the first message to the remote UE 110.

At block 920, the target BS 150 transmits, to the remote UE 110, a local ID of the remote UE 110.

At block 930, the target BS 150 performs, based on the local ID of the remote UE 110, a data transmission with the remote UE 110 via the target relay UE 120.

In some embodiments, the first message does not indicate the local ID of the remote UE 110. In these embodiments, the target BS 150 may establish a connection with the target relay UE 120. The target BS 150 may receive, from the target relay UE 120, a request for obtaining the local ID of the remote UE 110, and transmit, to the target relay UE 120, a fourth message indicating the local ID of the remote UE 110. In response to receiving, form the target relay UE 120, a response to the fourth message indicating that the switching is completed, the target BS 150 may transmit, to the remote UE 110, a second message indicating the local ID of the remote UE 110. In some embodiments, the target BS 150 may receive, from the remote UE 110 via the target relay UE 120, uplink data multiplexed with a response to the second message.

Alternatively, the target BS 150 may transmit the local ID of the remote UE 110 in the first message. In some embodiments, the target BS 150 may establish a connection with the target relay UE 120. The target BS 150 may receive, from the target relay UE 120, a request for obtaining the local ID of the remote UE, and transmit, to the target relay UE 120, a fourth message indicating the local ID of the remote UE. The target BS 150 may ensure that the same local ID of the remote UE 110 is sent to the target relay UE 120.

In some embodiments, the target BS 150 may further receive, from the target relay UE 120, a response to the fourth message indicating that the switching is completed. In some embodiments, the target BS 150 may receive, from the target relay UE, the uplink data multiplexed with the response to the fourth message.

Alternatively, the target BS 150 may not send the local ID of the remote UE 110 to the target relay UE 120. In these embodiments, the target BS 150 may establish a connection with the target relay UE 120, and receive, from the target relay UE 120, a response to the first message indicating that the switching is completed. In some embodiments, the target BS 150 may receive, from the target relay UE 120, uplink data multiplexed with the response to the first message.

With the method 900, a target BS may allocate a local ID for a remote UE and perform a data transmission with the remote UE via a target relay UE based on the local ID.

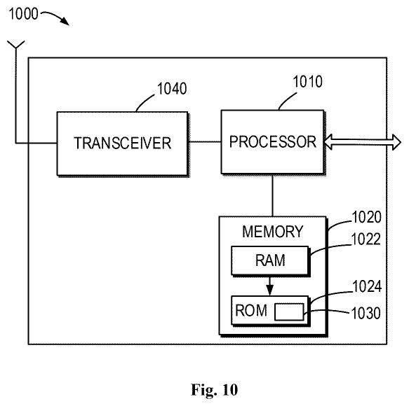

FIG. 10 is a simplified block diagram of a device 1000 that is suitable for implementing embodiments of the present disclosure. For example, the remote UE 110, the target relay UE 120 and the target BS 150 can be implemented by the device 1000. As shown, the device 1000 includes a processor 1010, a memory 1020 coupled to the processor 1010, and a transceiver 1040 coupled to the processor 1010.

The transceiver 1040 is for bidirectional communications. The transceiver 1040 is coupled to at least one antenna to facilitate communication. The transceiver 1040 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1030 so that the device 1000 may perform any process of the disclosure as discussed with reference to FIGS. 2-6. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out any of the methods 700 to 900 as described above with reference to FIGS. 7 to 9.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

Clause 1. A first user equipment (UE), comprising:
a transceiver configured to communicate with a network directly or via another UE; and
a processor communicatively coupled to the transceiver and configured to perform operations comprising:
   receiving, from the network, a first message indicating that the first UE is switched to communicate with the network via a second UE in an idle or inactive state;
   obtaining, from the second UE or the network, a local identity (ID) of the first UE; and
   performing, based on the local ID of the first UE, a data transmission with the network via the second UE.

Clause 2. The first UE of Clause 1, wherein the first message does not indicate the local ID of the first UE, and wherein the operations further comprise:
establishing a sidelink connection with the second UE; and
transmitting, to the network and via the second UE, a response to the first message indicating that the switching is completed, wherein the response does not comprise the local ID in a sidelink relay adaptation protocol (SRAP) header or does not comprise the SRAP header.

Clause 3. The first UE of Clause 2, wherein obtaining the local ID of the first UE comprises:
receiving, from the network and via the second UE, a second message indicating the local ID of the first UE.

Clause 4. The first UE of Clause 3, wherein performing the data transmission comprises:
transmitting, to the network and via the second UE, uplink data multiplexed with a response to the second message.

Clause 5. The first UE of Clause 2, wherein obtaining the local ID of the first UE comprises:
receiving, from the second UE and via the sidelink connection, a third message indicating the local ID of the first UE.

Clause 6. The first UE of Clause 5, wherein performing the data transmission comprises:
transmitting, to the network and via the second UE, uplink data comprising the local ID in a SRAP header.

Clause 7. The first UE of Clause 1, wherein the first message further indicates the local ID of the first UE, and wherein obtaining the local ID of the first UE comprises:
obtaining the local ID of the first UE from the first message.

Clause 8. The first UE of Clause 7, wherein the operations further comprise:
establishing a sidelink connection with the second UE; and
transmitting, to the network and via the second UE, a response to the first message indicating that the switching is completed, the response comprising the local ID in a sidelink relay adaptation protocol (SRAP) header.

Clause 9. The first UE of Clause 8, wherein performing the data transmission comprises:
transmitting, to the network and via the second UE, uplink data multiplexed with the response to the first message.

Clause 10. The first UE of Clause 7, wherein the operations further comprise:
receiving downlink data from the network via the second UE; and
in accordance with a determination that an ID of the first UE in a sidelink relay adaptation protocol (SRAP) header associated with the downlink data is different from the local ID obtained from the first message, triggering a radio resource control (RRC) re-establishment procedure.

Clause 11. A second user equipment (UE), comprising:
a transceiver configured to communicate with a network; and
a processor communicatively coupled to the transceiver and configured to perform operations comprising:
   receiving, from a first UE, a response to a first message, the first message indicating that the first UE is switched to communicate with the network via the second UE in an idle or inactive state, the response indicating that the switching is completed;
   obtaining, from the first UE or the network, a local identity (ID) of the first UE; and
   transmitting the response to the network based on the local ID of the first UE.

Clause 12. The second UE of Clause 11, wherein the response does not comprise the local ID in a sidelink relay adaptation protocol (SRAP) header or does not comprise the SRAP header, and wherein obtaining the local ID of the first UE comprises:
establishing a connection with the network;
transmitting, to the network, a request for obtaining the local ID of the first UE; and
receiving, from the network, a fourth message indicating the local ID of the first UE.

Clause 13. The second UE of Clause 12, wherein the operations further comprise:
transmitting, to the first UE, a third message indicating the local ID of the first UE;
receiving, from the first UE, uplink data comprising the local ID in a SRAP header; and
transmitting the uplink data to the network.

Clause 14. The second UE of Clause 11, wherein the response comprises the local ID in a sidelink relay adaptation protocol (SRAP) header, and wherein obtaining the local ID of the first UE comprises:
establishing a connection with the network;
transmitting, to the network, a request for obtaining the local ID of the first UE; and
receiving, from the network, a fourth message indicating the local ID of the first UE.

Clause 15. The second UE of Clause 14, wherein the operations further comprise:
receiving, from the first UE, uplink data multiplexed with the response to the first message; and
transmitting, to the network, the uplink data multiplexed with a response to the fourth message.

Clause 16. The second UE of Clause 11, wherein the response comprises the local ID in a sidelink relay adaptation protocol (SRAP) header, and wherein obtaining the local ID of the first UE comprises:
obtaining the local ID from the SRAP header.

Clause 17. The second UE of Clause 16, wherein transmitting the response comprises:
establishing a connection with the network; and
transmitting the response to the network.

Clause 18. The second UE of Clause 17, wherein the operations further comprise:
receiving, from the first UE, uplink data multiplexed with the response to the first message; and
transmitting, to the network, the uplink data multiplexed with the response to the first message.

Clause 19. A base station, comprising:
a transceiver configured to communicate with a first user equipment (UE) directly or via another UE; and
a processor communicatively coupled to the transceiver and configured to perform operations comprising:
   transmitting, to the first UE, a first message indicating that the first UE is switched to communicate with the base station via a second UE in an idle or inactive state;
   transmitting, to the first UE, a local identity (ID) of the first UE; and
   performing, based on the local ID of the first UE, a data transmission with the first UE via the second UE.

Clause 20. The base station of Clause 19, wherein the first message does not indicate the local ID of the first UE, and wherein transmitting the local ID of the first UE comprise:
establishing a connection with the second UE;
receiving, from the second UE, a request for obtaining the local ID of the first UE;
transmitting, to the second UE, a fourth message indicating the local ID of the first UE;
receiving, from the second UE, a response to the fourth message indicating that the switching is completed; and
transmitting, to the first UE, a second message indicating the local ID of the first UE.

Clause 21. The base station of Clause 20, wherein performing the data transmission comprise:
receiving, from the first UE, uplink data multiplexed with a response to the second message.

Clause 22. The base station of Clause 19, wherein transmitting the local ID of the first UE comprises:
transmitting the local ID of the first UE in the first message.

Clause 23. The base station of Clause 22, wherein the operations further comprise:
establishing a connection with the second UE;
receiving, from the second UE, a request for obtaining the local ID of the first UE;
transmitting, to the second UE, a fourth message indicating the local ID of the first UE; and
receiving, from the second UE, a response to the fourth message indicating that the switching is completed.

Clause 24. The base station of Clause 23, wherein performing the data transmission comprises:
receiving, from the second UE, uplink data multiplexed with the response to the fourth message.

Clause 25. The base station of Clause 22, wherein the operations further comprise:
establishing a connection with the second UE; and
receiving, from the second UE, a response to the first message indicating that the switching is completed.

Clause 26. The base station of Clause 25, wherein performing the data transmission comprises:
receiving, from the second UE, uplink data multiplexed with the response to the first message.

Clause 27. A method of communication, comprising:
receiving, at a first user equipment (UE) and from a network, a first message indicating that the first UE is switched to communicate with the network via a second UE in an idle or inactive state;
obtaining, from the second UE or the network, a local identity (ID) of the first UE; and
performing, based on the local ID of the first UE, a data transmission with the network via the second UE.

Clause 28. The method of Clause 27, wherein the first message does not indicate the local ID of the first UE, and wherein the method further comprises:
establishing a sidelink connection with the second UE; and
transmitting, to the network and via the second UE, a response to the first message indicating that the switching is completed, wherein the response does not comprise the local ID in a sidelink relay adaptation protocol (SRAP) header or does not comprise the SRAP header.

Clause 29. The method of Clause 28, wherein obtaining the local ID of the first UE comprises:
receiving, from the network and via the second UE, a second message indicating the local ID of the first UE.

Clause 30. The method of Clause 29, wherein performing the data transmission comprises:
transmitting, to the network and via the second UE, uplink data multiplexed with a response to the second message.

Clause 31. The method of Clause 28, wherein obtaining the local ID of the first UE comprises:
receiving, from the second UE and via the sidelink connection, a third message indicating the local ID of the first UE.

Clause 32. The method of Clause 31, wherein performing the data transmission comprises:
transmitting, to the network and via the second UE, uplink data comprising the local ID in a SRAP header.

Clause 33. The method of Clause 27, wherein the first message further indicates the local ID of the first UE, and wherein obtaining the local ID of the first UE comprises:
obtaining the local ID of the first UE from the first message.

Clause 34. The method of Clause 33, further comprising:
establishing a sidelink connection with the second UE; and
transmitting, to the network and via the second UE, a response to the first message indicating that the switching is completed, the response comprising the local ID in a sidelink relay adaptation protocol (SRAP) header.

Clause 35. The method of Clause 34, wherein performing the data transmission comprises:
transmitting, to the network and via the second UE, uplink data multiplexed with the response to the first message.

Clause 36. The method of Clause 33, further comprising:
receiving downlink data from the network via the second UE; and
in accordance with a determination that an ID of the first UE in a sidelink relay adaptation protocol (SRAP) header associated with the downlink data is different from the local ID obtained from the first message, triggering a radio resource control (RRC) re-establishment procedure.

Clause 37. A method of communication, comprising:
receiving, at a second user equipment (UE) and from a first UE, a response to a first message, the first message indicating that the first UE is switched to communicate with a network via the second UE in an idle or inactive state, the response indicating that the switching is completed;
obtaining, from the first UE or the network, a local identity (ID) of the first UE; and
transmitting the response to the network based on the local ID of the first UE.

Clause 38. The method of Clause 37, wherein the response does not comprise the local ID in a sidelink relay adaptation protocol (SRAP) header or does not comprise the SRAP header, and wherein obtaining the local ID of the first UE comprises:
establishing a connection with the network;
transmitting, to the network, a request for obtaining the local ID of the first UE; and
receiving, from the network, a fourth message indicating the local ID of the first UE.

Clause 39. The method of Clause 38, further comprising:
transmitting, to the first UE, a third message indicating the local ID of the first UE;
receiving, from the first UE, uplink data comprising the local ID in a SRAP header; and
transmitting the uplink data to the network.

Clause 40. The method of Clause 37, wherein the response comprises the local ID in a sidelink relay adaptation protocol (SRAP) header, and wherein obtaining the local ID of the first UE comprises:
establishing a connection with the network;
transmitting, to the network, a request for obtaining the local ID of the first UE; and
receiving, from the network, a fourth message indicating the local ID of the first UE.

Clause 41. The method of Clause 40, further comprising:
receiving, from the first UE, uplink data multiplexed with the response to the first message; and
transmitting, to the network, the uplink data multiplexed with a response to the fourth message.

Clause 42. The method of Clause 37, wherein the response comprises the local ID in a sidelink relay adaptation protocol (SRAP) header, and wherein obtaining the local ID of the first UE comprises:
obtaining the local ID from the SRAP header.

Clause 43. The method of Clause 42, wherein transmitting the response comprises:
establishing a connection with the network; and
transmitting the response to the network.

Clause 44. The method of Clause 43, further comprising:
receiving, from the first UE, uplink data multiplexed with the response to the first message; and
transmitting, to the network, the uplink data multiplexed with the response to the first message.

Clause 45. A method of communication, comprising:
transmitting, at a base station and to a first user equipment (UE), a first message indicating that the first UE is switched to communicate with the base station via a second UE in an idle or inactive state;
transmitting, to the first UE, a local identity (ID) of the first UE; and
performing, based on the local ID of the first UE, a data transmission with the first UE via the second UE.

Clause 46. The method of Clause 45, wherein the first message does not indicate the local ID of the first UE, and wherein transmitting the local ID of the first UE comprise:
establishing a connection with the second UE;
receiving, from the second UE, a request for obtaining the local ID of the first UE;
transmitting, to the second UE, a fourth message indicating the local ID of the first UE;
receiving, from the second UE, a response to the fourth message indicating that the switching is completed; and
transmitting, to the first UE, a second message indicating the local ID of the first UE

Clause 47. The method of Clause 46, wherein performing the data transmission comprise:
receiving, from the first UE, uplink data multiplexed with a response to the second message.

Clause 48. The method of Clause 45, wherein transmitting the local ID of the first UE comprises:
transmitting the local ID of the first UE in the first message.

Clause 49. The method of Clause 48, further comprising:
establishing a connection with the second UE;
receiving, from the second UE, a request for obtaining the local ID of the first UE;
transmitting, to the second UE, a fourth message indicating the local ID of the first UE; and
receiving, from the second UE, a response to the fourth message indicating that the switching is completed.

Clause 50. The method of Clause 49, wherein performing the data transmission comprises:
receiving, from the second UE, uplink data multiplexed with the response to the fourth message.

Clause 51. The method of Clause 48, further comprising:
establishing a connection with the second UE; and
receiving, from the second UE, a response to the first message indicating that the switching is completed.

Clause 52. The method of Clause 51, wherein performing the data transmission comprises:
receiving, from the second UE, uplink data multiplexed with the response to the first message.

Clause 53. A computer readable medium comprising program instructions for causing an apparatus to perform the method according to any of Clauses 27 to 36 or any of Clauses 37 to 44 or any of Clauses 45 to 52.

What is claimed is:

1. A first user equipment (UE), comprising:
a transceiver configured to communicate with a network directly or via another UE; and
a processor communicatively coupled to the transceiver and configured to perform operations comprising:
receiving, from the network, a first message indicating that the first UE is switched to communicate with the network via a second UE in an idle or inactive state;
obtaining, from the second UE or the network, a local identity (ID) of the first UE; and
performing, based on the local ID of the first UE, a data transmission with the network via the second UE.

2. The first UE of claim 1, wherein the first message does not indicate the local ID of the first UE, and wherein the operations further comprise:
establishing a sidelink connection with the second UE; and
transmitting, to the network and via the second UE, a response to the first message indicating that the switching is completed, wherein the response does not comprise the local ID in a sidelink relay adaptation protocol (SRAP) header or does not comprise the SRAP header.

3. The first UE of claim 2, wherein obtaining the local ID of the first UE comprises:
receiving, from the network and via the second UE, a second message indicating the local ID of the first UE.

4. The first UE of claim 3, wherein performing the data transmission comprises:
transmitting, to the network and via the second UE, uplink data multiplexed with a response to the second message.

5. The first UE of claim 2, wherein obtaining the local ID of the first UE comprises:
receiving, from the second UE and via the sidelink connection, a third message indicating the local ID of the first UE.

6. The first UE of claim 5, wherein performing the data transmission comprises:
transmitting, to the network and via the second UE, uplink data comprising the local ID in a SRAP header.

7. The first UE of claim 1, wherein the first message further indicates the local ID of the first UE, and wherein obtaining the local ID of the first UE comprises:
obtaining the local ID of the first UE from the first message.

8. The first UE of claim 7, wherein the operations further comprise:
establishing a sidelink connection with the second UE; and
transmitting, to the network and via the second UE, a response to the first message indicating that the switching is completed, the response comprising the local ID in a sidelink relay adaptation protocol (SRAP) header.

9. The first UE of claim 8, wherein performing the data transmission comprises:
transmitting, to the network and via the second UE, uplink data multiplexed with the response to the first message.

10. The first UE of claim 7, wherein the operations further comprise:
receiving downlink data from the network via the second UE; and
in accordance with a determination that an ID of the first UE in a sidelink relay adaptation protocol (SRAP) header associated with the downlink data is different from the local ID obtained from the first message, triggering a radio resource control (RRC) re-establishment procedure.

11. A second user equipment (UE), comprising:
a transceiver configured to communicate with a network; and
a processor communicatively coupled to the transceiver and configured to perform operations comprising:
receiving, from a first UE, a response to a first message, the first message indicating that the first UE is switched to communicate with the network via the second UE in an idle or inactive state, the response indicating that the switching is completed;
obtaining, from the first UE or the network, a local identity (ID) of the first UE; and
transmitting the response to the network based on the local ID of the first UE.

12. The second UE of claim 11, wherein the response does not comprise the local ID in a sidelink relay adaptation protocol (SRAP) header or does not comprise the SRAP header, and wherein obtaining the local ID of the first UE comprises:
establishing a connection with the network;
transmitting, to the network, a request for obtaining the local ID of the first UE; and
receiving, from the network, a fourth message indicating the local ID of the first UE.

13. The second UE of claim 12, wherein the operations further comprise:
transmitting, to the first UE, a third message indicating the local ID of the first UE;
receiving, from the first UE, uplink data comprising the local ID in a SRAP header; and
transmitting the uplink data to the network.

14. The second UE of claim 11, wherein the response comprises the local ID in a sidelink relay adaptation protocol (SRAP) header, and wherein obtaining the local ID of the first UE comprises:
establishing a connection with the network;
transmitting, to the network, a request for obtaining the local ID of the first UE; and
receiving, from the network, a fourth message indicating the local ID of the first UE.

15. The second UE of claim 14, wherein the operations further comprise:
receiving, from the first UE, uplink data multiplexed with the response to the first message; and
transmitting, to the network, the uplink data multiplexed with a response to the fourth message.

16. The second UE of claim 11, wherein the response comprises the local ID in a sidelink relay adaptation protocol (SRAP) header, and obtaining the local ID of the first UE comprises:
obtaining the local ID from the SRAP header.

17. A base station, comprising:
a transceiver configured to communicate with a first user equipment (UE) directly or via another UE; and
a processor communicatively coupled to the transceiver and configured to perform operations comprising:
transmitting, to the first UE, a first message indicating that the first UE is switched to communicate with the base station via a second UE in an idle or inactive state;
transmitting, to the first UE, a local identity (ID) of the first UE; and
performing, based on the local ID of the first UE, a data transmission with the first UE via the second UE.

18. The base station of claim 17, wherein the first message does not indicate the local ID of the first UE, and wherein transmitting the local ID of the first UE comprise:
establishing a connection with the second UE;
receiving, from the second UE, a request for obtaining the local ID of the first UE;
transmitting, to the second UE, a fourth message indicating the local ID of the first UE;
receiving, from the second UE, a response to the fourth message indicating that the switching is completed; and
transmitting, to the first UE, a second message indicating the local ID of the first UE

19. The base station of claim 18, wherein performing the data transmission comprise:
receiving, from the first UE, uplink data multiplexed with a response to the second message.

20. The base station of claim 17, wherein transmitting the local ID of the first UE comprises:
transmitting the local ID of the first UE in the first message.
